(19) United States
(12) Patent Application Publication
(10) Pub. No.: US 2025/0004232 A1
(43) Pub. Date: Jan. 2, 2025

(54) TELECOMMUNICATIONS DISTRIBUTION ELEMENTS

(71) Applicant: COMMSCOPE CONNECTIVITY BELGIUM BVBA, Kessel-Lo (BE)

(72) Inventors: Willem Lea Marcel DE VIS, Merchtem (BE); David Jan Irma VAN BAELEN, Winksele (BE); Eric Marcel M. KEUSTERMANS, Houwaart (BE); Heidi BLEUS, Genk (BE); Geert Antoon PARTON, Lubbeek (BE)

(73) Assignee: COMMSCOPE CONNECTIVITY BELGIUM BVBA, Kessel-Lo (BE)

(21) Appl. No.: 18/820,474

(22) Filed: Aug. 30, 2024

Related U.S. Application Data
(63) Continuation of application No. 17/794,921, filed on Jul. 22, 2022, now Pat. No. 12,099,246.
(60) Provisional application No. 62/965,241, filed on Jan. 24, 2020.

(51) Int. Cl. G02B 6/44

(52) U.S. Cl. CPC G02B 6/4452; G02B 6/4455

(57) ABSTRACT

An optical fiber distribution element includes a chassis defining an interior; a movable tray slidably movable from within the chassis to a position at least partially outside the chassis, the tray defining a front end and a rear end; a slide mechanism which connects the movable tray to the chassis; at least one hingedly mounted frame member within the tray which hinges about an axis perpendicular to the direction of movement of the movable tray; and a cover mounted adjacent the rear end of the tray and movable between an access position and an operational position when the tray is in the open position, only the operational position of the cover allowing the tray to move from the open position to the closed position, the access position allowing access to the at least one hingedly mounted frame member, and the cover in the access position preventing the tray from moving from the open to the closed position.

### CROSS-REFERENCE TO RELATED APPLICATIONS

The present application is a Continuation of U.S. patent application Ser. No. 17/794,921, filed on Jul. 22, 2022; which is a National Stage Application of PCT/EP2021/051368, filed on Jan. 21, 2021; which claims the benefit of U.S. Patent Application Ser. No. 62/965,241, filed on Jan. 24, 2020, the disclosures of which are incorporated herein by reference in their entireties. To the extent appropriate, a claim of priority is made to each of the above disclosed applications.

### FIELD OF THE INVENTION

The present invention relates to telecommunications distribution systems, e.g., optical fiber distribution systems, which may include a rack and elements which populate the rack, wherein such fiber optic elements can include fiber terminations, patching, fiber splitters, and fiber splices.

### BACKGROUND OF THE INVENTION

Optical fiber distribution systems may include fiber terminations and other equipment which is typically rack mounted. Various concerns exist for the optical fiber distribution systems, including density, ease of use and mounting, and cable management. There is a continuing need for improvements in the telecommunications distribution area, especially optical fiber distribution.

### SUMMARY OF THE INVENTION

One implementation of a system in accordance with the examples of the disclosure includes a building block element mountable to a rack or other structure. The element includes a chassis and a movable tray. The tray is movably mounted to the chassis with a slide mechanism that allows the tray to slide relative to the chassis, wherein the tray may house equipment for fiber terminations, patching, splitting, and splicing.

The elements can be stacked in a column with each tray slideable in a horizontal direction. In the case of a column of elements, a selected tray is pulled outward to access the desired tray.

In an example embodiment of a fiber optic distribution element, one side of each element can be for patch cables, and the opposite side can be for cable termination of an incoming cable, such as a distribution cable or a feeder cable. The elements can be configured as desired and form building blocks for an optical fiber distribution system. When the elements are mounted in a column in a rack, the cables can be placed in vertical cable guides to enter and exit the selected element. An example rack may be front accessible. However, the elements shown and described can be used in other racks, frames, cabinets, or boxes including in arrangements where rear access is desirable or useful.

According to an aspect of the disclosure, the disclosure is directed to an optical fiber distribution element that includes a chassis defining an interior; a movable tray slidably movable from within the chassis to a position at least partially outside the chassis, the tray defining a front end and a rear end; a slide mechanism which connects the movable tray to the chassis; at least one hingedly mounted frame member within the tray which hinges about an axis perpendicular to the direction of movement of the movable tray; and a cover mounted adjacent the rear end of the tray and movable between an access position and an operational position when the tray is in the open position, only the operational position of the cover allowing the tray to move from the open position to the closed position, the access position allowing access to the at least one hingedly mounted frame member, and the cover in the access position preventing the tray from moving from the open to the closed position.

### BRIEF DESCRIPTION OF THE FIGURES

FIG. 1 is an embodiment of an optical fiber distribution element having features that are examples of inventive aspects in accordance with the present disclosure, the optical fiber distribution element depicted as a drawer-based dedicated splice element that includes within its tray cable management structures for guiding cabling to and from the hinged splice frames.

FIG. 2 illustrates the tray portion of the optical fiber distribution element of FIG. 1 in isolation removed from the chassis of the element.

FIG. 3 shows the cover of the tray of FIG. 2 in an open position to illustrate the hinged splice frames provided within the tray.

FIG. 3A shows a close-up view of the hinge of the cover of FIG. 3.

FIG. 4 shows the tray of FIGS. 2-3 without the cover or the hinged splice frames to illustrate the details of the inventive cable management structures within the tray.

FIG. 5 illustrates a prior art version of the locking feature provided between a tray such as that shown in FIGS. 2-4 and a hinged splice frame therein for pivotally mounting the splice frame within such a tray.

FIG. 6 illustrates a locking feature provided between the tray of FIGS. 2-4 and one of the hinged splice frames shown in FIG. 3 for pivotally mounting the splice frame within the tray, the locking feature having inventive aspects in accordance with the present disclosure.

FIG. 7 illustrates an example version of a tube holder that is configured to be mounted within the tray of FIGS. 2-4 that can frictionally support fiber carrying tubes.

FIG. 8 illustrates another version of a tray similar to the tray of FIGS. 2-4 that includes a further cable management wall on both sides of the tray for guiding cabling within the tray.

FIG. 9 is a top perspective view of a retainer configured to be mounted within a tray such as the tray of FIGS. 2-4, the retainer configured to hold a plurality of cable termination units in a stacked arrangement.

FIG. 10 is a bottom perspective view of the retainer of FIG. 9.

FIG. 11 is another top perspective view of the tray of FIGS. 2-4 shown without the cover or the hinged splice frames to illustrate an example of a cable retention feature having inventive aspects, the cable retention feature formed from two flexible fingers that provide a push-through design, the cable retention feature provided on both sides of the tray.

### DETAILED DESCRIPTION

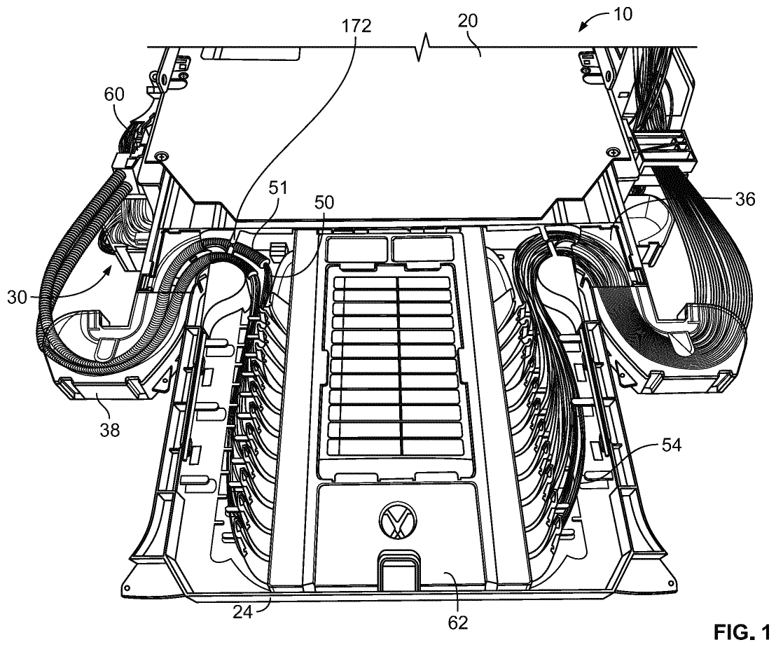

Referring now to FIGS. 1-11, various embodiments of an optical fiber distribution element 10 are shown. The element 10 can be individually mounted as desired to telecommunications equipment including racks, frames, or cabinets. The element 10 can be mounted in groups or blocks which can form a stacked arrangement. In one embodiment, a vertical stack of elements 10 can populate an optical fiber distribution rack.

Each element 10 can hold fiber terminations or other fiber components including fiber splitters and/or fiber splices.

The example depicted optical fiber distribution element 10 that is going to be referenced for describing the inventive features of the disclosure is a drawer-based dedicated splice element that includes, within its tray, cable management structures for guiding cabling to and from hinged splice frames (also referred to herein as splice trays).

As shown, the element 10 includes a chassis 20 and a movable tray 24. Tray 24 is movable with a slide mechanism 30. Slide mechanism 30 provides for synchronized movement for managing the cables extending to and from tray 24. Entry points 36 on either side of chassis 20 allow for fixation of the input and output cables associated with each element 10. U-shaped radius limiters 38 associated with each slide mechanism 30 move in synchronized movement relative to chassis 20 and tray 24 to maintain fiber slack, without causing fibers to be bent, pinched, or pulled.

Further details relating to such slide mechanisms that can be used in the distribution element 10 are described and illustrated in PCT Publication No. WO 2019/201878, the entire disclosure of which is hereby incorporated by reference.

Referring specifically to FIG. 1, as noted above, the depicted optical fiber distribution element 10 that is going to be referenced for describing the inventive features of the disclosure is a dedicated splice element that includes, within its tray, cable management structures for guiding cabling to and from the hinged splice frames.

In the depicted element, incoming outside plant (OSP) cabling 50 (e.g., 250 micron/900 micron optical fibers) may be directed to pivotally mounted splice frames 52 (may also be referred to as splice trays or pivot trays). Within the splice trays 52, each fiber of the OSP cable 50 may be spliced to a pigtail 54 (i.e., outgoing cabling) that may lead to another element or other points in the network such as other equipment or customer dwellings.

As shown, the incoming cabling 50 may follow a path from an exterior of the element 10, through U-shaped movable radius limiters 38, to the interior pivot trays 52. After the splice operation, the outgoing cabling 54 may follow a similar path, where the cabling 54 is routed through U-shaped radius limiters 38 at the opposite side of the elements 10. As shown, the incoming cabling 50 may be provided with strength members that are secured to the sides of the elements via cable fixation devices 60 such as those described in PCT Publication No. WO 2019/201878, which has been incorporated herein by reference.

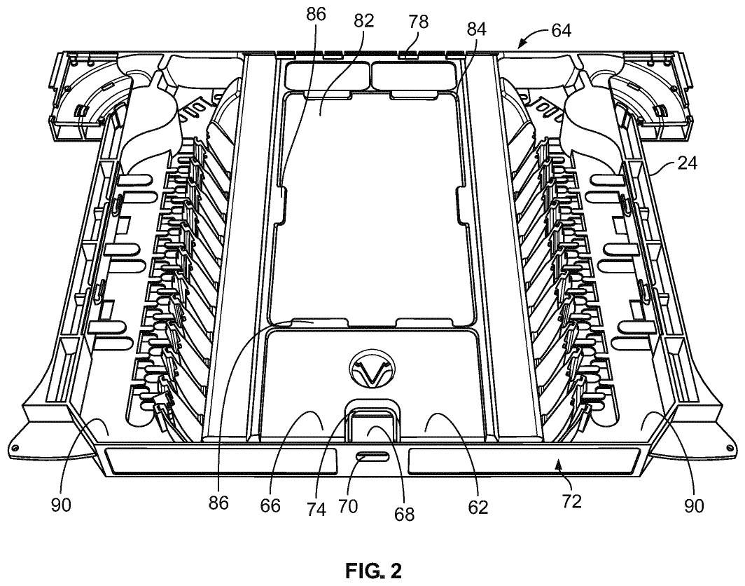

Referring now to FIGS. 2-11, certain inventive interior features of the trays 24 of elements such as the element 10 shown in FIG. 1 will be described.

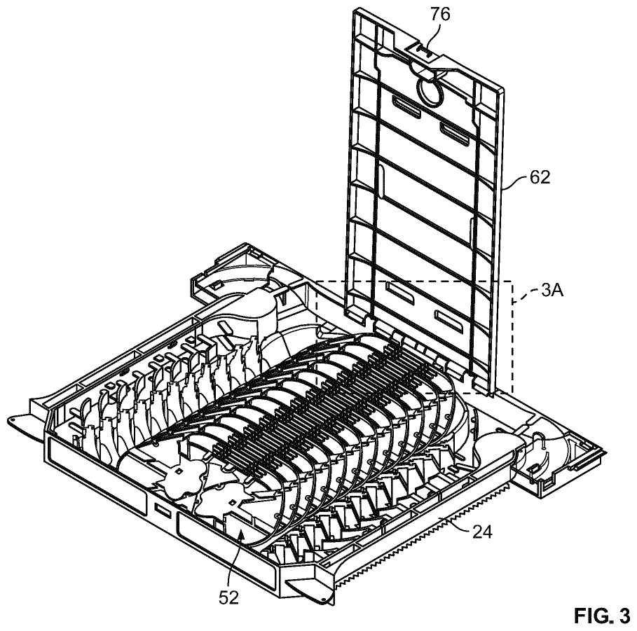

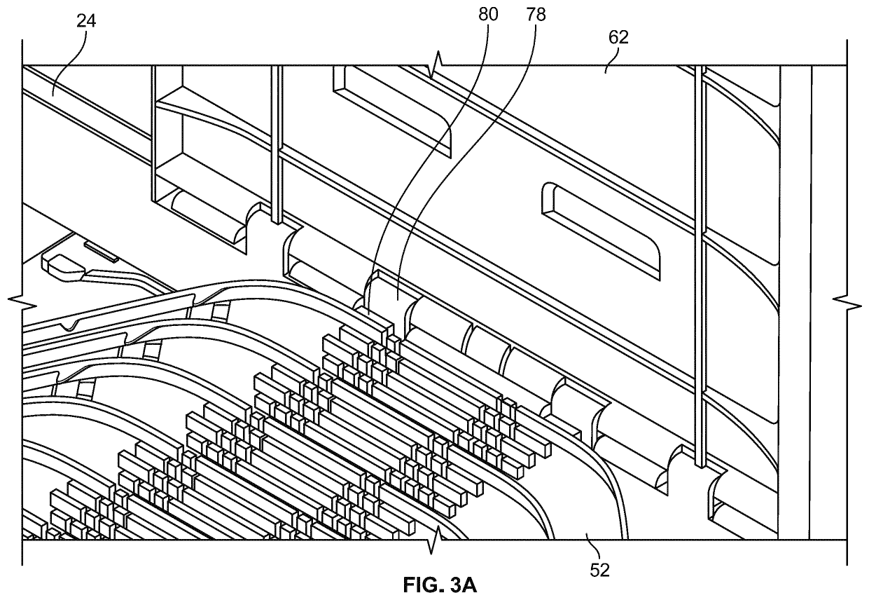

FIGS. 2-3 illustrate the details of a cover portion 62 of the tray 24 that is configured to protect the pivotally mounted splice frames 52 provided along a center portion of the tray 24. As shown, the cover 62 is hinged adjacent a back end 64 of the tray 24 and is openable in a front-to-back direction, where the cover 62 is pivotally liftable from a front end 66 of the cover 62. A flexible latch 68 provided at the front 66 of the cover 62 is used to keep the cover 62 closed by being snap-fit into a latch opening 70 provided at a front end 72 of the tray 24. A latch grip 74 can be elastically moved by a user in a front-to-back direction to free a latch lip 76 from the latch opening 70 before pivotally lifting the cover 62.

The arrangement of the cover 62 where the hinge is positioned at the back end 64 of the tray 24 provides a safety feature for protecting the splice trays 52 and the fibers therein within the tray 24. Each of the splice frames or trays 52 first must be pivoted down before the cover 62 itself can be brought down and snapped to a closed position. When the cover 62 is at an open position, slideable closure of the tray 24 is prevented by contact of the cover 62 with the chassis 20 of the distribution element 10. And, since closure of the cover 62 requires closure of each of the splice trays 52, accidental closure of the tray 24 and pinching or damaging any of the fibers within the splice trays 52 is prevented or at least limited.

Without the cover 62, if the tray 24 was closed with any of the splice trays 52 in an open position, a front edge of the top of the chassis 20 of the element 10 might damage the trays 52 or the fibers therein. To prevent such a closure and the potential resulting damage, cover 62 is configured to prevent movement of tray 24 to the closed position when cover 62 is not in the closed position itself as noted above. The closed position of the cover 62 may also be referred to as the operational position, and the open position of the cover 62 may be referred to as the access position where the splice trays 52 may be accessed.

A hinge 78 of the cover 62 and a hinge receiver 80 of the tray 24 may be configured such that the cover 62 remains or is locked in an open position when pivoted open. According to one example configuration, the hinge 78 of the cover 62 may utilize a square or other polygonal shaped cross-section where sharp edges of the cross-section provide temporary stops within the hinge receiver 80 to enable the cover 62 to remain open when brought to an open position. In such an example, the hinge 78 of the cover 62 and the hinge receiver 80 of the tray 24 provide a self-supporting locking system to keep the cover 62 in an open position without the need for further structures or features.

As also shown in FIG. 2, the cover 62 may be used to house a card 82 (i.e., identification card) that can be used to write or provide connectivity information thereon regarding the distribution element 10. The card 82 is removably mounted to a card slot 84 provided on the cover 62 via tabs 86 provided around the perimeter of the card slot 84. Even though the card 82 is removable from the cover 62, the cover 62 provides access to the card 82 such that distribution information can be written on the card 82 without removal from the cover 62.

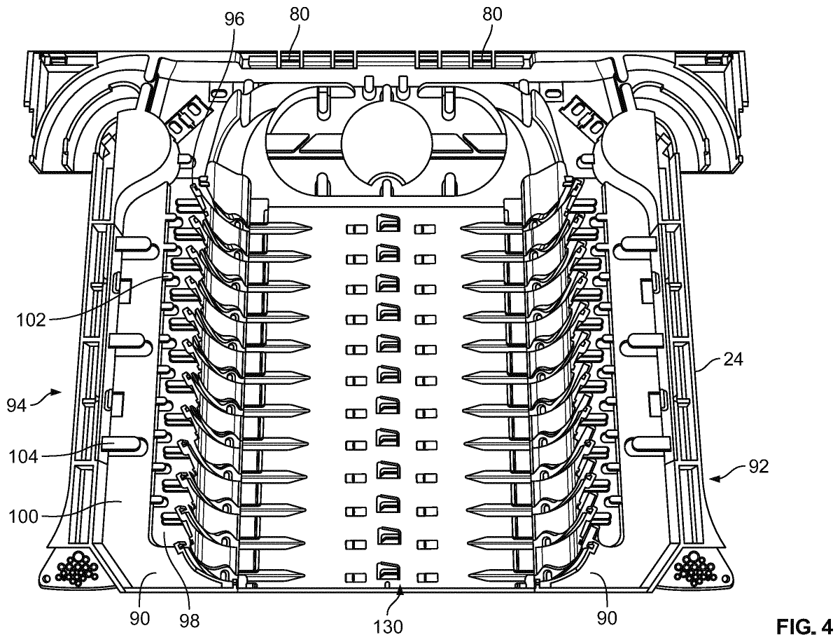

FIG. 4 shows the tray 24 of FIGS. 2-3 without the cover 62 or the hinged splice frames 52 to illustrate the details of inventive cable management structures 90 within the tray 24.

As shown, a cable management structure 90 is provided at each of the right and left sides 92, 94 of tray 24. The cable management structures 90 are for guiding cabling to and from the hinged splice trays 52.

According to one example embodiment as depicted, the cable management structure 90 may be provided as a removable insert. As such, if the cable management insert 90 is damaged in any way, the insert may be replaced with another. In other embodiments, the cable management structure may be integrally molded with the tray of the distribution element 10.

In the depicted embodiment, each cable management insert 90 extends in a front-to-back direction, on opposing sides of the flip trays 52. A series of curved radius limiters 96 are provided for guiding cabling to and from the splice trays 52.

In the depicted example, each cable management insert 90 defines a double layered cable routing channel defined by a lower channel 98 and an upper channel 100, wherein cable management fingers 102 separate the lower channel 98 from the upper channel 100.

According to an example configuration as shown in FIG. 1, the lower channel 98 may be used for 250 micron or 900 micron optical fibers 50 and the upper channel 100 may be used for the pigtails 54. The dual layered construction provides a physical separation between two different types of cabling and may provide extra protection to the smaller 250 micron or 900 micron optical fibers 50 in the lower channel 98. As shown, the upper channel 100 is also provided with cable retention fingers 104 extending into and partially covering the upper channel 100 for retaining the pigtails 54 within the upper channel 100.

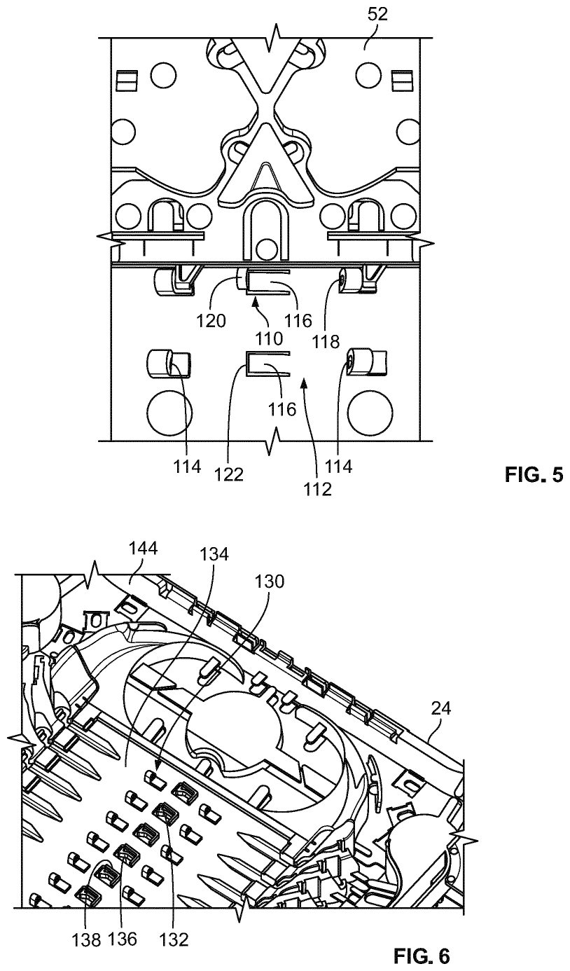

Now referring to FIGS. 5 and 6, details on the locking feature for pivotally mounting the splice frames 52 to the tray 24 are illustrated.

FIG. 5 illustrates a prior art version of a locking feature 110 provided between a tray such as the tray 24 shown in FIGS. 2-4 and a hinged splice frame 52 therein for pivotally mounting the splice frame 52 within such a tray 24.

As shown in the example of FIG. 5, each frame mounting location 112 within the tray 24 defines hinge openings 114 and a flexible ramped tab 116 positioned between the hinge openings 114. Hinge pins 118 defined on each splice tray 52 are configured to be horizontally slidably inserted into the hinge openings 114 while a retention tab 120 defined on the splice tray 52 slides over and pushes down on the flexible ramped tab 116. Once the flexible ramped tab 116 is cleared, the retention tab 120 is locked in against a stop surface 122 defined by the ramped tab 116. In this manner, the splice trays 52 are limited from removal unless the ramped tab 116 is flexed down and the hinge pins 118 are slid.

FIG. 6 illustrates an improved version of a locking feature 130 provided between the tray 24 of FIGS. 2-4 and the hinged splice frames 52. In the version of FIG. 6, a flexible ramped tab 132 is provided with flexibility along a horizontal plane defined by a bottom surface/wall 134 of the tray 24, which is in a perpendicular direction relative to the flex direction shown for the version of the tab 116 in FIG. 5. As shown in FIG. 6, in the improved locking feature 130, the flexible ramped tab 132 is provided within an aperture 136 defined by the bottom wall 134 of the tray 24. Edges 138 defining the aperture 136 provide positive stops for the flexible ramped tab 132 so as to limit over-flexing of the ramped tab 132. In this manner, the flexible ramped tab 132 has a limit in its travel and is not as susceptible to breaking off.

In contrast, in the version of the locking feature 110 in FIG. 5, the flexible ramped tab 116 is not limited in its travel since the ramped tab 116 is not provided with any positive stops. Thus, repetitive flexing of the ramped tab 116 in FIG. 5 might result in faster deformation or failure of the tab 116 versus the ramped tab 132 shown in FIG. 6 which is provided with a positive stop.

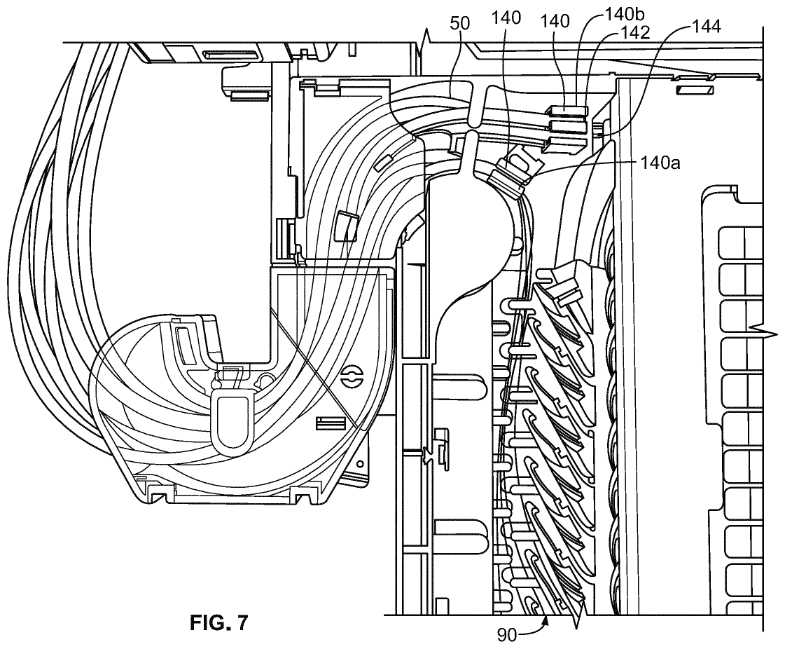

Referring now to FIG. 7, details relating to example tube holders 140 that are configured to be mounted within the tray 24 of FIGS. 2-4 that can frictionally support fiber carrying tubes 50 is discussed.

As shown, the tube holders 140 may be mounted so as to align with the channels of the movable U-shaped radius limiters 38 of the distribution elements 10. The tube holders 140 may be configured for tubes holding 250 micron fibers or for tubes holding 900 micron fibers, depending on the application. The tube holders 140 include friction members 142 which limit the amount of sliding movement of cables 50 passing through the tube holders 140, to assist with cable management. Friction members 142 grip lightly on the cables 50 in the tube holders 140 to reduce or eliminate sliding movement of the cables 50 therein.

Such tube holders 140 may also be positioned at various locations within the trays 24 for guiding of cabling in the preferred paths. As shown in an example layout in FIG. 7, one of the tube holders 140a is positioned to lead fiber carrying tubes 50 toward the cable management insert 90.

As also shown, a second tuber holder 140b may be positioned and may also cooperate with a channel 144 defined at the back 64 of the tray 24 to lead fiber carrying tubes to an opposite side of the tray 24 to provide for a side-switching concept. The second tube holder 140b that is shown to be provided at the rear 64 of the tray 24 can be mounted at either the right side 92 or the left side 94 of the tray 24 and may bypass the splice frames 52 on one side and lead fiber carrying tubes to the opposite side depending upon the connectivity need.

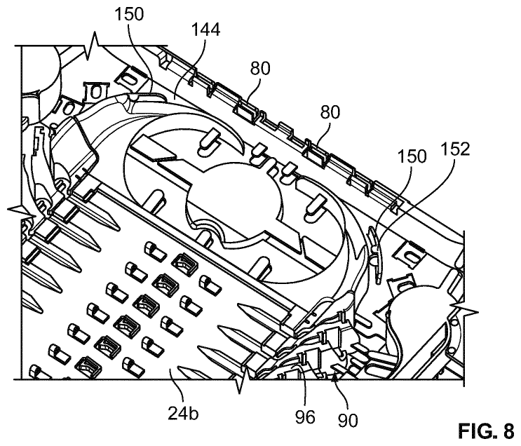

FIG. 8 illustrates another version of a tray 24b similar to the tray 24 of FIGS. 2-4 that includes a further cable management wall 150 on both sides of the tray 24b for guiding cabling within the tray 24b. For example, the cable management walls 150 can cooperate with the cable channel 144 at the back 64 of the tray 24b and guide fiber holding tubes extending from an opposite side of the tray 24b toward the radius limiters 96 defined by the cable management insert 90 when a side-switching operation is performed. Each cable management wall 150 is provided with a cable retention finger 152 for retaining the cables.

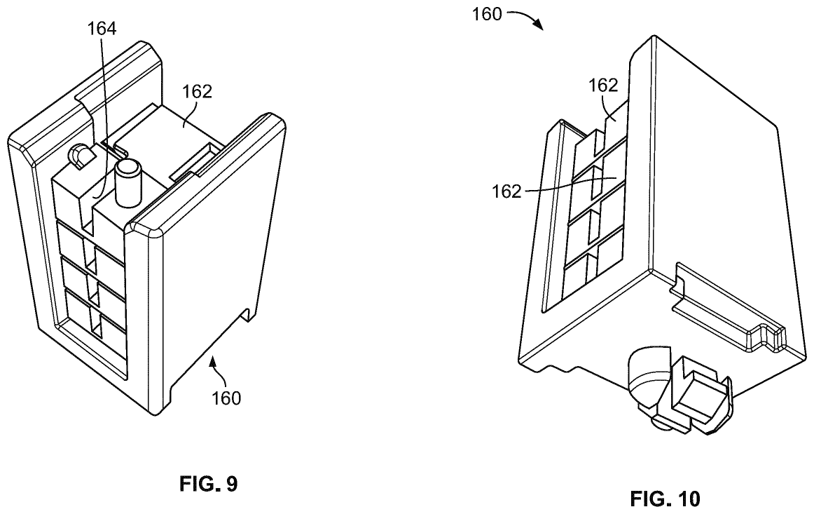

FIGS. 9-10 illustrate a retainer 160 configured to be mounted within a tray such as the tray 24 of FIGS. 2-4. The retainer 160 is configured to hold a plurality of cable termination units 162 in a stacked arrangement. The example retainer 160 has the same mounting interface as the above-discussed tube holders 140 and can be mounted at various locations within the tray 24. In the depicted embodiment, each retainer 160 is shown to hold four cable termination units 162 in a stacked arrangement. Other numbers are certainly possible depending upon connectivity need. The cable termination units 162 allow termination of cables inside the trays 24. A cable channel 164 is defined for receiving the cable. Strength members may be tied down or clamped within each cable termination unit 162 for securing the cables.

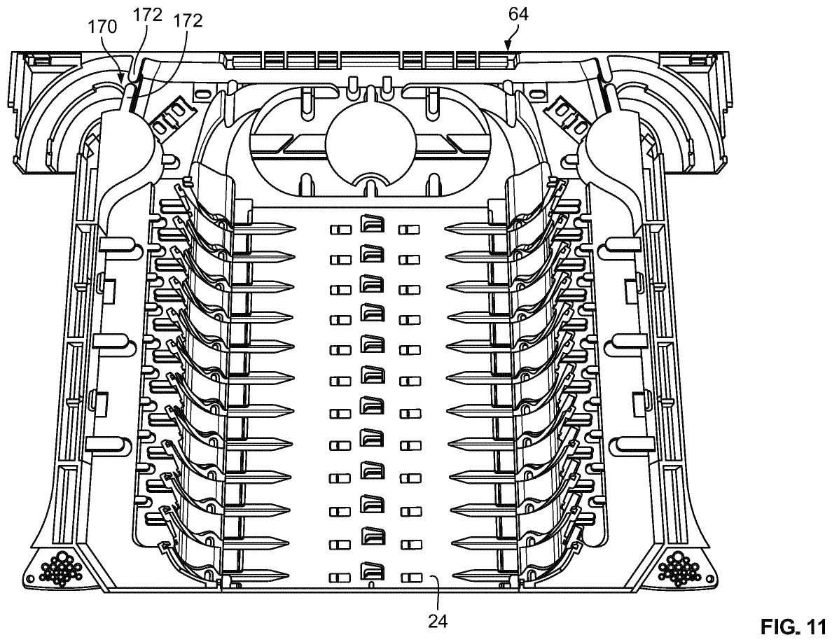

FIG. 11 illustrates an example of another cable retention feature 170 having inventive aspects. The cable retention feature 170 is shown to be used at both sides of the tray 24 adjacent to the back end 64 for transitioning cabling 50 (FIG. 1) from the U-shaped cable radius managers 38 to the main body of the tray 24. In one example, the cable retention feature 170 is formed from two flexible fingers 172 that provide a push-through design. The flexible fingers 172 allow cabling 50 surrounded by corrugated tubes 51 (i.e., flex tubes) or pigtails to be pushed through and retained thereunder.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. An optical fiber distribution element comprising:
a chassis defining an interior;
a movable tray slidably movable from within the chassis to a position at least partially outside the chassis, the tray defining a front end and a rear end;
at least one hingedly mounted frame member within the tray which hinges about an axis perpendicular to the direction of movement of the movable tray; and
a cover mounted to the tray and movable between an access position and an operational position when the tray is in an open position, only the operational position of the cover allowing the tray to move from the open position to a closed position, the access position allowing access to the at least one hingedly mounted frame member, and the cover in the access position preventing the tray from moving from the open to the closed position.

2. The element of claim 1, wherein the tray includes a plurality of frame members hingedly mounted for independent movement, each of the frame members being coverable by the cover.

3. The element of claim 2, wherein the plurality of frame members are stacked along a line which is generally parallel to the direction of travel of the movable tray.

4. The element of claim 1, wherein the movable tray is slidably mounted to the chassis via a slide mechanism, wherein the slide mechanism includes a radius limiter which moves with synchronized movement relative to the chassis and the tray during slidable movement of the tray.

5. The element of claim 1, wherein a cable entering or exiting the movable tray follows an S-shaped pathway as the cable extends between an exterior of the movable tray and the at least one hingedly mounted frame member.

6. The element of claim 1, wherein the at least one hingedly mounted frame member is configured to support a fiber optic splice.

7. The element of claim 1, wherein the cover includes a removable card for receiving indicia relating to fiber optic connectivity information within the movable tray.

8. The element of claim 1, wherein the cover includes a hinge that is received by a hinge receiver defined on the movable tray, the hinge of the cover and the hinge receiver of the tray cooperatively configured to automatically keep the cover in the access position when the cover has been brought to the access position.

9. The element of claim 4, further comprising a cable management structure within the tray for managing cables extending between the slide mechanism and the at least one hingedly mounted frame member within the tray, the cable management structure defining a two-layered structure defining a lower channel separated from an upper channel by cable management fingers.

10. The element of claim 9, wherein the cable management structure is provided as a removable insert.

11. The element of claim 9, wherein the tray includes two of the cable management structures, each located at an opposite side of the at least one hingedly mounted frame member.

12. The element of claim 11, wherein the tray includes therein a different type of cable within the upper channel of at least one of the cable management structures than the type of cable within the lower channel of at least one of the cable management structures.

13. The element of claim 1, wherein the at least one hingedly mounted frame member is removably mounted to the tray via a locking structure.

14. The element of claim 13, wherein the locking structure is defined by a hinge pin and a spaced apart retention tab on the frame member and a hinge opening and a flexible tab defined on the tray, the hinge opening configured to receive the hinge pin and the flexible tab configured to elastically flex to receive the retention tab and to provide a stop surface to prevent slidable movement of the retention tab.

15. The element of claim 14, wherein the flexible tab is provided within an aperture defined by the tray, at least one edge of the tray defining the aperture configured to provide a positive stop to limit flexible movement of the flexible tab.

16. An optical fiber distribution element comprising:
a tray; and
at least one hingedly mounted frame member within the tray which hinges about a hinge axis relative to the tray;
wherein the at least one hingedly mounted frame member is removably mounted to the tray via a locking structure, wherein the locking structure is defined by a hinge pin and a spaced apart retention tab defined on the frame member and a hinge opening and a flexible tab defined on the tray, the hinge opening configured to receive the hinge pin in an insertion direction that is parallel to the hinge axis and the flexible tab configured to elastically flex along a horizontal plane defined by a bottom wall of the tray to receive the retention tab and to provide a stop surface to prevent slidable movement of the retention tab in a direction that is opposite of the insertion direction of the hinge pin into the hinge opening, and wherein the flexible tab is provided within an aperture defined by the tray, wherein at least one edge of the tray that defines the aperture is configured to provide a positive stop to limit flexible movement of the flexible tab along the horizontal plane defined by the bottom wall of the tray.

17. The element of claim 16, wherein the tray includes a plurality of frame members hingedly mounted for independent movement.

18. The element of claim 17, wherein the plurality of frame members are provided in a stacked arrangement with the hinge axes of the frame members being parallel.

19. The element of claim 16, wherein the at least one hingedly mounted frame member is configured to support a fiber optic splice.

20. The element of claim 16, wherein the at least one hingedly mounted frame member includes cable management structures therewithin for managing cables within the frame member.

21. The element of claim 16, wherein the tray is a movable tray that is configured to slide with respect to a chassis, the movable tray slidably movable from within the chassis to a position at least partially outside the chassis, wherein the at least one hingedly mounted frame member hinges about the hinge axis that is perpendicular to the direction of movement of the movable tray.

22. The element of claim 21, further comprising a cover mounted to the tray and movable between an access position and an operational position when the tray is in an open position relative to the chassis, only the operational position of the cover allowing the tray to move from the open position to a closed position, the access position allowing access to the at least one hingedly mounted frame member, and the cover in the access position preventing the tray from moving from the open to the closed position.
